(19) United States
(12) Patent Application Publication
(10) Pub. No.: US 2017/0282220 A1
(43) Pub. Date: Oct. 5, 2017

(54) Method and System for Liquid Cleaning of Smoke Sensor Heads

(71) Applicant: Tyco Fire & Security GmbH, Neuhausen am Rheinfall (CH)

(72) Inventors: Anthony Philip Moffa, Northborough, MA (US); Chad Albert Goyette, Tiverton, RI (US)

(21) Appl. No.: 15/088,610

(22) Filed: Apr. 1, 2016

(51) Int. Cl. B08B 3/10; G08B 17/103; C11D 7/30; B08B 3/14; B08B 9/00

(52) U.S. Cl. CPC B08B 3/102; B08B 3/14; B08B 9/00; C11D 7/30; G08B 17/103

(57) ABSTRACT

A system and method for cleaning the fire detection sensor of a fire detection device, such as a smoke detector, includes flowing halocarbon liquid over the fire detection sensor. A pump continuously recirculates the halocarbon liquid between a sensor holder and a reservoir, while a cleaning action is applied by an agitator to the fire detection sensor while it is under a stream of the liquid or in a bath of the liquid. The halocarbon liquid is typically an industrial electronics cleaner such as Novec™, which removes dirt, dust, grease and oil from the fire detection sensor without harming electronic components.

### BACKGROUND OF THE INVENTION

Fire alarm systems are often installed within commercial, residential, educational, or governmental buildings, to list a few examples. These fire alarm systems typically include fire detection devices, which monitor the buildings for indicators of fire.

One common type of fire detection devices is photoelectric (or optical) smoke detectors. The optical smoke detectors often include a baffle system (which defines a detection chamber) that functions to block ambient light while also allowing air to flow into and through the detection chamber. The optical smoke detectors further include a smoke detection system within the detection chamber for detecting the presence of smoke. The smoke detection system typically comprises a chamber light source and a scattered light photodetector. When smoke fills the detection chamber it causes the light from the chamber light source to be scattered within the chamber and detected by the scattered light photodetector. When no smoke or other scatter medium is present, the photodetector only receives a small background signal from the light source.

As air flows through the detection chamber over time, dirt and dust can accumulate inside and around the detection chamber. This is especially true for detectors installed in harsh environments such as kitchens or rooms with cigarette smoke. Additionally, it is not uncommon for insects or spiders to build nests or webs in or on the detectors. Even in detectors installed in environments that are not considered harsh (such as offices), dirt and dust gradually accumulate inside the detection chamber. This can cause problems such as reduced blocked airflow through the baffle systems, decreased dynamic range of the detectors (due to an increased baseline or background light detection level within the chamber), or blocked photodetectors.

### SUMMARY OF THE INVENTION

Currently, detectors can be cleaned by a variety of methods. Pressurized air can be blown into the detection chambers in order to force the dirt and dust out. Similarly, a vacuum can be used to suck the dirt out. The problem with these methods is that they are often not effective in practice. Dirt and dust are blown around within the chamber but not necessarily removed. It is possible to dismantle the detector by removing the outer and inner covers from the detection chamber in order to access it directly; however, this method is time consuming. Furthermore, it is not uncommon for the tabs on the covers to break during the process of dismantling them.

At the same time, industrial electronics cleaners are available. Halocarbon liquids are capable of removing dirt, dust, grease and oils from electronic devices without damaging the electronic components.

In general, according to one aspect, the invention features a system for cleaning fire detection devices. Additionally the system includes a holder for holding one or more fire detection devices while being bathed in a halocarbon liquid and a reservoir for capturing the halocarbon liquid.

In embodiments, the cleaning system can include a holder that includes a slot for receiving the fire detection device, a pump for drawing the halocarbon liquid from the reservoir and flowing the liquid over the fire detection device in the sensor holder, an agitator for vibrating or turning the fire detection device, and/or a filter for filtering impurities from the liquid (after exiting the detector chamber but before reentering the pump).

In some embodiments, the agitator vibrates and/or turns the fire detection device in a stream of the halocarbon liquid. In other embodiments, the agitator vibrates and/or turns the fire detection device in a bath of the halocarbon liquid. In still other embodiments, the fire detection device is submersed in a bath of the liquid

Additionally, in some embodiments, the halocarbon liquid is a fluorinated ketone.

In one example, the fire detection device is a smoke sensor, such as a photoelectric smoke sensor with a smoke chamber.

In general, according to another aspect, the invention features a method for cleaning of fire detection devices. The method includes inserting the fire detection device in a holder and bathing the fire detection device a halocarbon liquid.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a top view illustrating an example of a fire detection sensor head of a fire detection device with the smoke chamber exposed;

FIG. 2A is a schematic diagram of an embodiment of a cleaning system for cleaning the fire detection sensor head of a fire detection device, in which the agitator causes the fire detection sensor to vibrate;

FIG. 2B is a schematic diagram of an embodiment of a cleaning system for cleaning the fire detection sensor head of a fire detection device, in which the agitator causes the fire detection sensor to rotate;

FIG. 3 is a flow diagram for a method of cleaning a fire detection sensor using the cleaning system;

FIG. 4A illustrates an example of how the fire detection sensor head is removed from the base unit of the fire detection device, in which the fire detection sensor is turned counter clockwise;

FIG. 4B illustrates an example of how the fire detection sensor is removed from the base unit of a fire detection device, in which the fire detection sensor is detached from the base unit;

FIG. 5 is a top view showing another embodiment of the cleaning system; and

FIG. 6 is a perspective view showing still another embodiment of the cleaning system.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

In a typical implementation, a fire detection device includes a base unit and a head unit. These components are typically made from molded plastic. Typically, the head unit connects to the base unit, which is fastened to a wall or ceiling of a building.

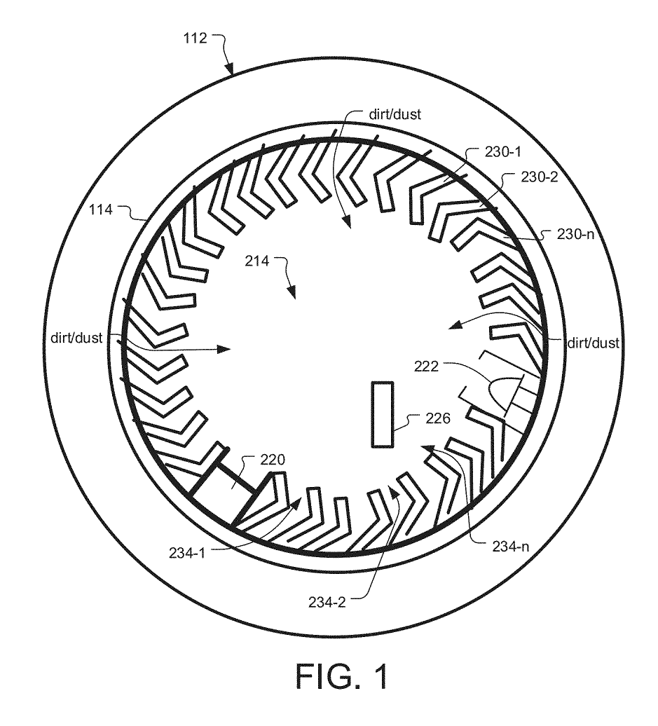

FIG. 1 is a cross-sectional view illustrating an example of a detection chamber in the head unit of a fire detection device. The head unit 112 includes the detection chamber 214, a smoke detection system, and a baffle system 230.

The detection chamber 214 is defined by the baffle system 230, which includes individual baffles 230-1 to 230-n. The arrangement of the baffles 230-1 to 230-n form pathways 234-1 to 234-n that allow air, smoke, and also dirt and dust to flow through the detection chamber 214. The baffles are also commonly referred to as vanes, walls, or labyrinths, to list a few examples. A protective wire screen 114 surrounds the baffle system 230 to prevent bugs and other large debris from entering the detection chamber 214.

The smoke detection system detects the presence of smoke within the detection chamber 214. In the illustrated example, the smoke detection system comprises a chamber light source 222 for generating light and a scattered light photodetector 220 for detecting light that has been scattered due to the smoke or other scattering medium collecting within the detection chamber 214.

If smoke is present in the detection chamber 214, the light from the source 222 is reflected and scattered by the smoke and detected by the scattered light photodetector 220. A blocking baffle 226 is installed within the detection chamber 214 to prevent the light from having a direct path to the scattered light photodetector 220.

Over time, air flow results in the accumulation of dirt and dust within the detection chamber 214, on the baffles 230, and on the scattered light photodetector 220 has a scattering effect on the light generated by the light source 222 and thus affects the operation of the smoke detection system and specifically the baseline or background light level detected by the photodetector. This change will affect the available dynamic range of the system (reducing it) and eventually will adversely impact the sensitivity setting of the smoke detector. As the baseline value goes up with dirt accumulation, the available dynamic range of the sensor reduces. If untouched, the sensor will eventually get to a point where the baseline has moved up enough that the available range is less than the programmed alarm setting (the alarm value is greater than the remaining range of the circuit). In this case, the detector will generate an alarm at the circuit full range (even though it is less than the alarm level). This makes the smoke detector more sensitive to smoke.

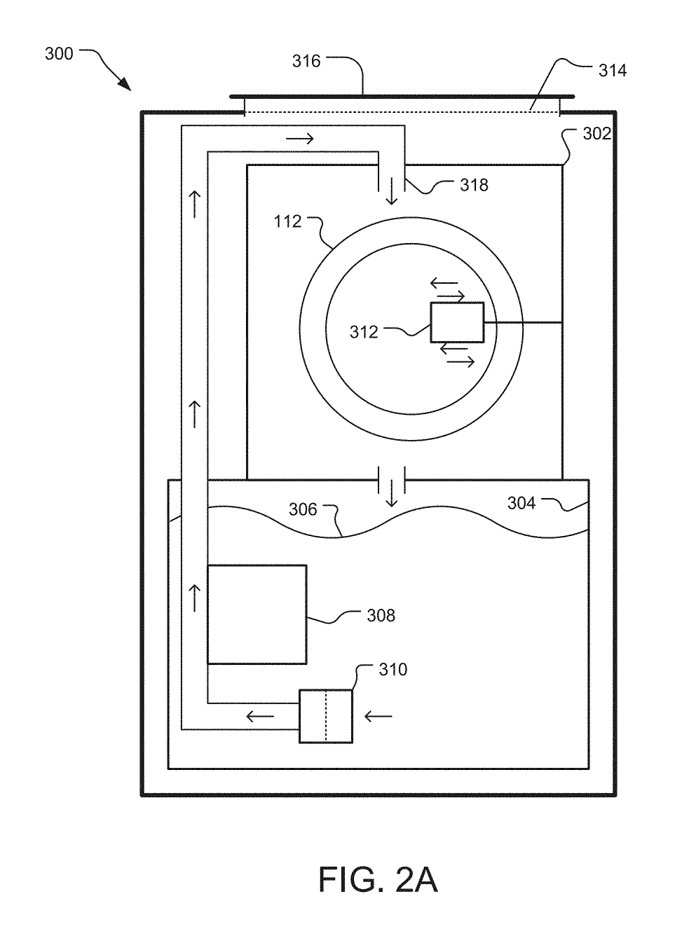

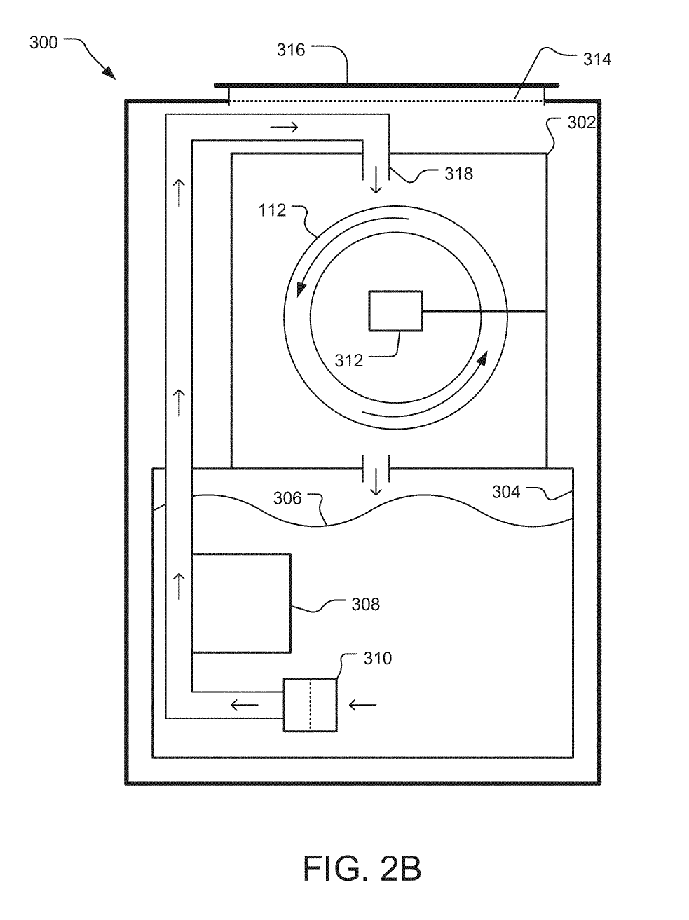

FIG. 2A is a schematic diagram of a cleaning system 300 for cleaning the fire detection sensor of a fire detection device. The cleaning system 300 includes a sensor holder 302, a reservoir 304, a halocarbon liquid 306 in the reservoir 304, a pump 308, a filter 310, an agitator 312, a lid 316, and an outlet 318.

The sensor holder 302 is a chamber within the cleaning system 300 that holds the fire detection device head unit 112. In one embodiment, the sensor holder 302 receives the head unit 112 through a slot 314, which is an opening in the top of the cleaning system 300. In the illustrated example, the holder 302 holds the head unit 112 in a vertical orientation, in which the plane of its base extends vertically. In other examples, it holds the head unit 112 in a horizontal orientation with the chamber lower than the base.

The reservoir 304 is a chamber within the cleaning system 300 that captures and holds the halocarbon liquid 306.

The halocarbon liquid 306 is an industrial electronics cleaner which is used to remove dirt, dust, grease and oils from electronics devices without damaging the electronic components. A common example of a halocarbon liquid 306 is Novec™ engineered fluid. This fluid is a fluorinated ketone. The halocarbon liquid 306 is poured into the reservoir 304 before the cleaning process begins, typically.

The pump 308 draws the halocarbon liquid 306 through the filter 310, which removes impurities from the liquid, and flows the liquid through the outlet 318 over the head unit 112 held in the sensor holder 302.

The agitator 312 is a device that moves the head unit 112 relative to the liquid while it is in contact with the halocarbon liquid 306. This movement creates a washing action, which is generally more effective at removing dirt, dust, grease and oil than flowing the liquid over the head unit 112 while it is stationary. In the illustrated embodiment, the agitator 312 causes the head unit 112 to vibrate. FIG. 2B shows an alternative embodiment, wherein the agitator 312 causes the head unit 112 to rotate.

The halocarbon liquid 306 then flows out of the sensor holder 302 and is captured in the reservoir 304.

In general, the cleaning system 300 cleans the head unit 112 by continuously recirculating the halocarbon liquid 306 from the reservoir 304 over the head unit 112 into the sensor holder 302 while the agitator 312 applies the cleaning action to the head unit 112.

In one embodiment, the halocarbon liquid 306 forms a stream under which the agitator 312 applies the washing action to the head unit 112. In another embodiment, the halocarbon liquid 306 forms a bath in which the agitator 312 applies the washing action to the head unit 112.

Finally, the lid 316 enables easy transportation of the system 300 once the halocarbon liquid 306 is placed in the unit and prevents evaporation of the halocarbon liquid 306.

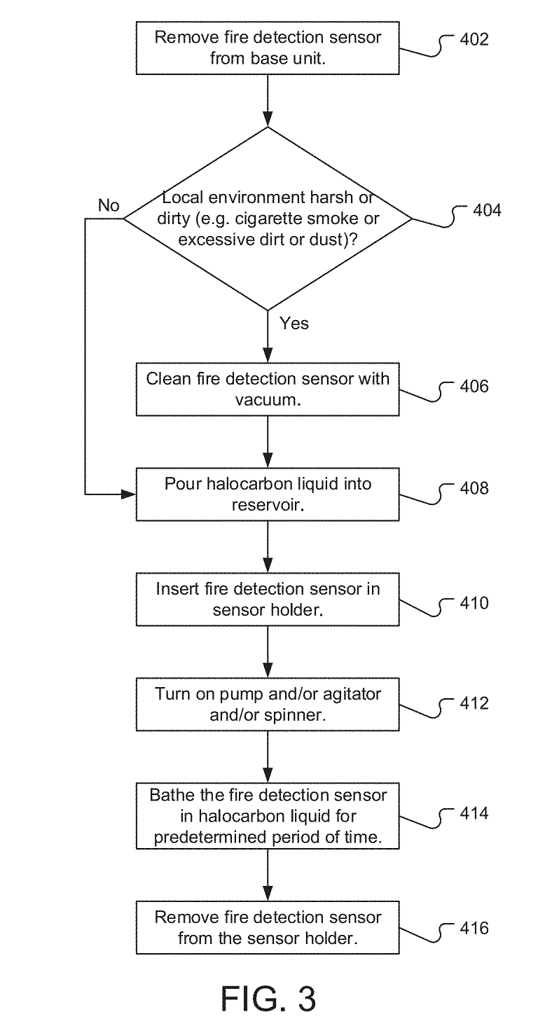

FIG. 3 is a flow diagram for a method of cleaning a fire detection sensor 112 using the cleaning system 300.

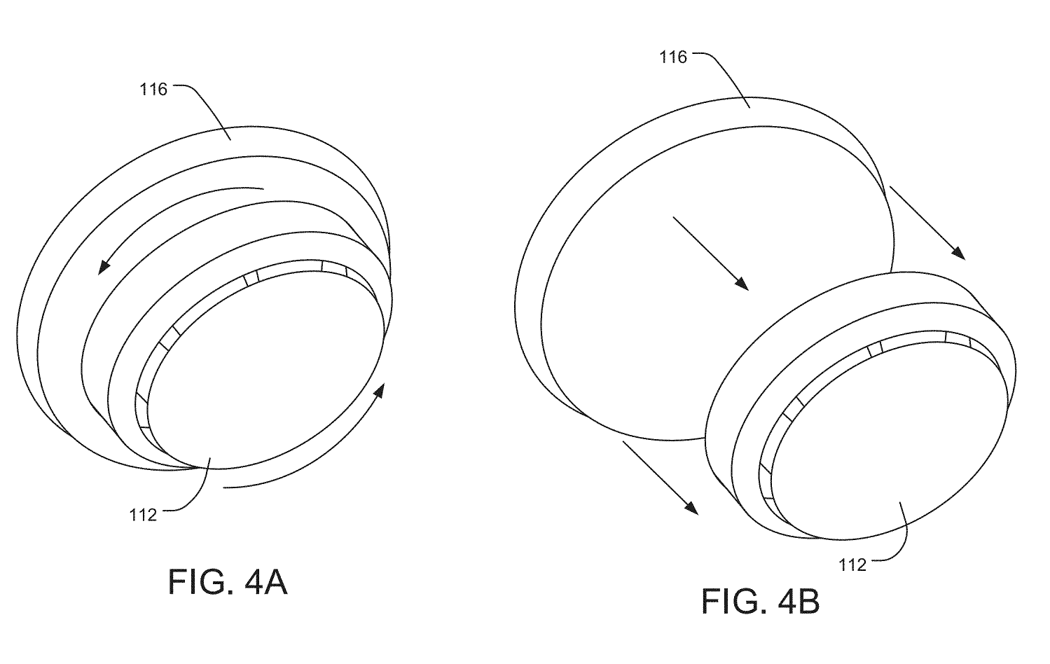

In step 402, the fire head unit 112 is removed from the base unit. FIGS. 4A-4B illustrate an example of how the head unit 112 is removed. FIG. 4A shows the head unit 112 attached to the base unit 116. In this example, the head unit 112 is released by turning it counter clockwise. FIG. 4B shows the head unit 112 detached from the base unit 116.

Returning to FIG. 3, in step 404 it is determined whether the head unit 112 was part of a fire detection device installed in a local environment that was particularly harsh or dirty. For example, the fire detection device might have been installed in a casino where cigarette smoking is common or a kitchen with smoke from cooking. If the local environment is determined to be harsh, in step 406, the head unit 112 is first cleaned with a vacuum. In other embodiments, the head unit 112 is cleaned in this preliminary step using other methods such as pressurized air.

In step 408, the halocarbon liquid 306 is poured into the reservoir 304 of the cleaning system 300. Then, in step 410, the head unit 112 is inserted into the sensor holder 302 through the slot 314. The pump 308 and the agitator 312 are then turned on in step 412. In step 414, the head unit 112 is bathed in the halocarbon liquid 306 for a predetermined period of time. Finally, in step 416, the head unit 112 is removed from the sensor holder 302.

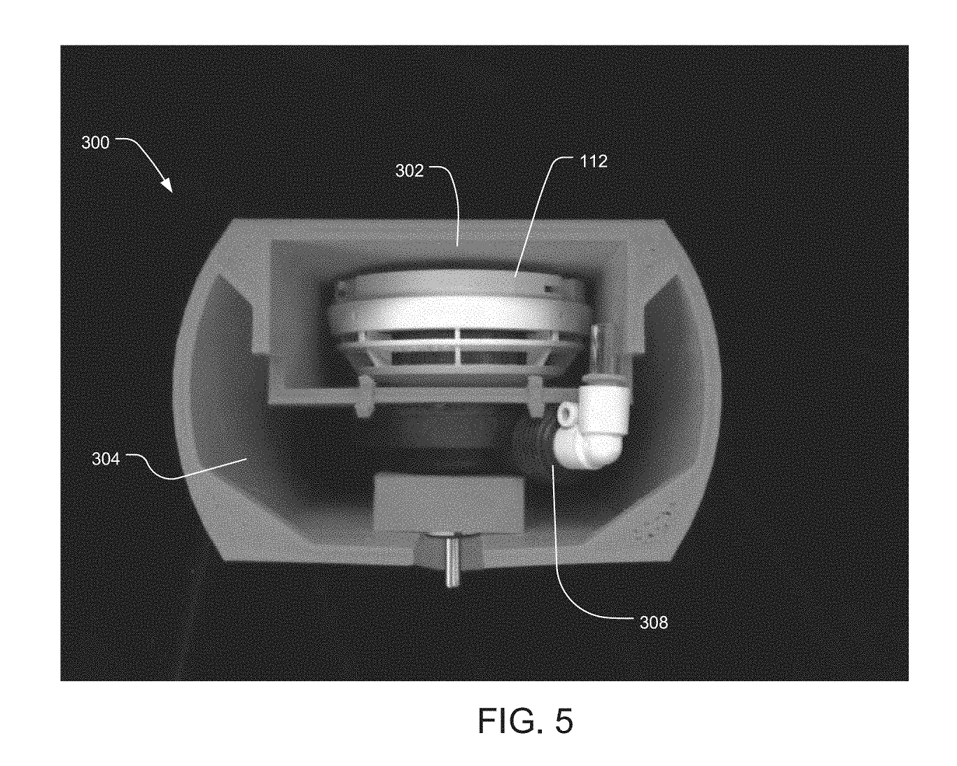

FIG. 5 shows one embodiment of the cleaning system 300. It shows the head unit 112 inserted into the holder 302. The pump 308 is located in the reservoir 304.

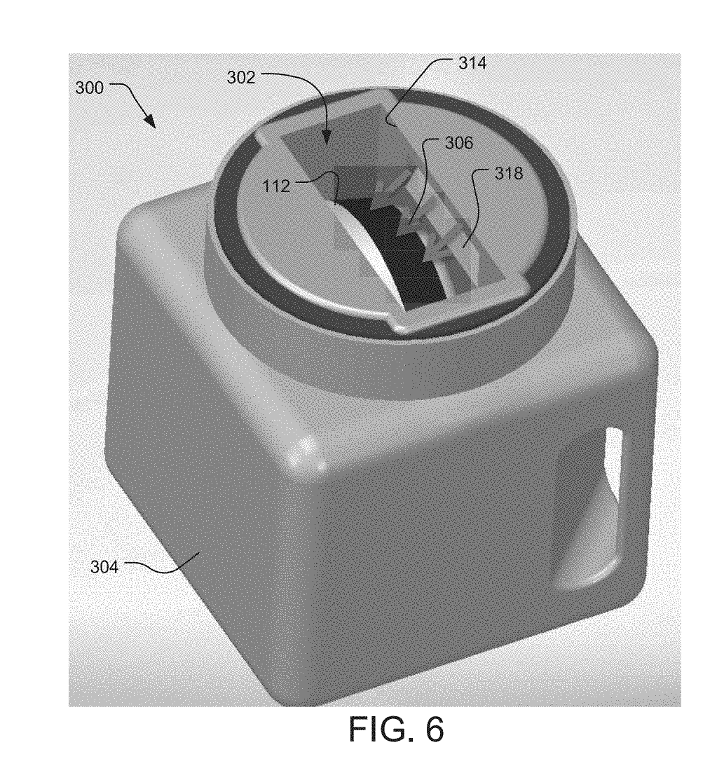

FIG. 6 shows another embodiment of the cleaning system 300. It shows the head unit 112 inserted into the sensor holder 302 through the slot 314. The halocarbon liquid 306 is illustrated by arrows flowing out of the outlet 318 over the head unit 112. The exterior of the reservoir 304 is shown. Not shown is the pump 308 and the filter 310, both of which are inside the reservoir 304.

While this invention has been particularly shown and described with references to preferred embodiments thereof, it will be understood by those skilled in the art that various changes in form and details may be made therein without departing from the scope of the invention encompassed by the appended claims.

What is claimed is:

1. A system for cleaning of fire detection devices, comprising:
a holder for holding one or more fire detection devices while being bathed in a halocarbon liquid; and
a reservoir for capturing the halocarbon liquid.

2. The system as claimed in claim 1, wherein the fire detection device is a smoke sensor.

3. The system as claimed in claim 1, wherein the fire detection device is a photoelectric smoke sensor with a smoke chamber.

4. The system as claimed in claim 1, wherein the holder includes a slot for receiving a head unit of the fire detection device.

5. The system as claimed in claim 1, further comprising a pump for drawing the halocarbon liquid from the reservoir and flowing the liquid over the fire detection device held in the sensor holder.

6. The system as claimed in claim 1, further comprising an agitator for vibrating or turning the fire detection device relative to a stream of the halocarbon liquid.

7. The system as claimed in claim 1, further comprising an agitator for vibrating or turning the fire detection device in a bath of the halocarbon liquid.

8. The system as claimed in claim 1, wherein the halocarbon liquid is a fluorinated ketone.

9. The system as claimed in claim 1, further comprising a filter for filtering impurities from the liquid.

10. A method for cleaning of fire detection devices, comprising:
inserting the fire detection device in a holder; and
bathing the fire detection device a halocarbon liquid.

11. The method as claimed in claim 10, wherein the fire detection device is a smoke sensor.

12. The method as claimed in claim 10, wherein the fire detection device is a photoelectric smoke sensor with a smoke chamber.

13. The method as claimed in claim 10, wherein the holder includes a slot for receiving a head unit of the fire detection device.

14. The method as claimed in claim 10, further comprising capturing the halocarbon liquid in a reservoir.

15. The method as claimed in claim 14, further comprising recirculating the halocarbon liquid from the reservoir to flow over the fire detection device.

16. The method as claimed in claim 10, further comprising vibrating or turning the fire detection device in a stream of the halocarbon liquid.

17. The method as claimed in claim 10, further comprising vibrating or turning the fire detection device in a bath of the halocarbon liquid.

18. The method as claimed in claim 10, wherein the halocarbon liquid is a fluorinated ketone.

19. The method as claimed in claim 10, wherein the halocarbon liquid is a Novec™ engineered fluid.
